(19) United States
(12) Patent Application Publication
(10) Pub. No.: US 2021/0354753 A1
(43) Pub. Date: Nov. 18, 2021

(54) METHOD OF STABILIZATION BY ORIENTATION OF A CONVOY OF VEHICLES

(71) Applicant: COMMISSARIAT A L'ENERGIE ATOMIQUE ET AUX ENERGIES ALTERNATIVES, PARIS (FR)

(72) Inventors: Alain MICAELLI, FONTENAY-AUX-ROSES (FR); Eric LUCET, PARIS (FR)

(21) Appl. No.: 16/325,708

(22) PCT Filed: Jul. 18, 2017
(86) PCT No.: PCT/EP2017/068122

§ 371 Date: Feb. 14, 2019

(30) Foreign Application Priority Data
Aug. 26, 2016 (FR) 1657959

(51) Int. Cl. B62D 12/02; B62D 47/00

(52) U.S. Cl. CPC B62D 12/02; B60D 1/481; B62D 47/006

(57) ABSTRACT

A method for stabilization of a convoy of vehicles linked in pairs one behind the other, includes a lead vehicle and at least one second vehicle comprising a front axle assembly with two wheels that are rotationally mobile about a front axis, a rear axle assembly with two wheels that are rotationally mobile about a rear axis, the front axis of a second vehicle coinciding with the rear axis of the vehicle preceding it, an articulation configured to render the rear axle assembly rotationally mobile about a vertical axis substantially at right angles to the reference plane relative to the front axle assembly, a sensor intended to estimate an orientation of the second vehicle, a computer, the method comprising the following steps: estimation of the position and the orientation of the vehicles, determination of the deviation between the actual trajectory and the reference trajectory, computation of a control vector to be applied to the two wheels of the front axle assembly, application of the first control vector to the two wheels of the front axle assembly of each second vehicle.

The invention relates to the field of the stabilization of a convoy of mechanically coupled vehicles and relates to a method for stabilization of a convoy of vehicles by orientation. The invention relates also to a convoy of vehicles linked in pairs one behind the other.

There are convoys of vehicles linked in pairs one behind the other such as a truck with several trailers or a road train, for example a tourist train, with a lead vehicle and wagons mechanically coupled one behind the other. Convoys of self-service vehicles can also be cited. In fact, the self-service vehicles in an urban and suburban environment are undergoing a rapidly increasing growth. There is often to be found a great concentration of vehicles in some stations to the detriment of others. In order to balance the number of self-service vehicles at all the stations, it is necessary to redirect self-service vehicles from the stations with a wealth of vehicles to the stations with few vehicles. For that, in order not to mobilize too many drivers, there is the possibility of mechanically coupling the self-service vehicles provided for this purpose and thus form a convoy of several vehicles, for example two, three, even eight or more, the convoy being driven by a single driver. The invention is illustrated in this particular case but is not limited to the application to self-service vehicles and can be applied to any type of convoy of vehicles.

This type of convoy of vehicles presents a stability problem. In fact, when the convoy is moved, the linked vehicles can perform undesirable lateral oscillations. These oscillations are more or less significant depending on the trajectory of the convoy and its speed. This oscillating is dangerous, difficult to control and can lead to the complete loss of control of the convoy. In the extreme, it may result the jackknifing of the convoy, that is to say that one of the vehicles of the convoy forms an acute angle with another of the vehicles of the convoy, like a folded jackknife.

Other situations can generate such oscillations. One case that can in particular be cited is a trajectory to avoid successive obstacles requiring all of the convoy to circumvent the obstacles, involving oscillations of the vehicles of the convoy. On a banking, it is also possible for a convoy of vehicles to lose shape. Similarly, a strong side wind can cause the convoy to oscillate.

By reflex, the driver of the tractor vehicle, generally the first vehicle of the convoy or lead vehicle, slows down as soon as he or she perceives such an oscillation or brakes to stop the convoy. However, this solution sometimes proves ineffective or the braking occurs too late and the maneuver ends nevertheless in a jackknifing.

There are also solutions implementing a control method for damping the oscillations, but this type of solution requires the detection of the oscillations and the discrimination thereof relative to an oscillation desired by the driver, that is to say that the convoy of vehicles is already oscillating and it is often too late to make a correction. The driver must therefore undergo a certain level of oscillations. Furthermore, however weak, oscillations can prove dangerous.

The invention aims to overcome all or some of the abovementioned problems by proposing a method for controlling a convoy of vehicles linked in pairs one behind the other, that makes it possible to detect the slightest deviation between the actual trajectory and the desired reference trajectory so as to correct as necessary the position and/or the orientation of each of the vehicles, before the occurrence of the lateral oscillations.

To this end, the subject of the invention is a method for stabilization by orientation of a convoy of vehicles linked in pairs one behind the other, intended to move on a reference plane along a reference trajectory, the convoy of vehicles following an actual trajectory, the convoy comprising:
a lead vehicle capable of moving along a main axis, comprising
   a front axle assembly with two wheels capable of being oriented along an axis of orientation forming, with the main axis, an angle of orientation,
   a rear axle assembly with two wheels that are rotationally mobile about a rear axle assembly,
   a first sensor intended to estimate a position and an orientation of the lead vehicle,
at least one second vehicle comprising:
   a front axle assembly with two wheels that are rotationally mobile about a front axis,
   a rear axle assembly with two wheels that are rotationally mobile about a rear axis, the front axis of a second vehicle coinciding with the rear axis of the vehicle preceding it,
   an articulation configured to render the rear axle assembly rotationally mobile about a vertical axis substantially at right angles to the reference plane relative to the front axle assembly,
   a second sensor intended to estimate an orientation of the second vehicle,
a computer,
   the reference trajectory of the convoy being composed of the actual trajectory of the lead vehicle and the trajectory of the second vehicles driven by the lead vehicle and to which no external effort is applied,
   the method according to the invention comprising the following steps:
estimation by the sensors of the position of the lead vehicle and the orientation of the vehicles determination by the computer of the deviation between the actual trajectory and the reference trajectory from the estimations of the sensors,
if the deviation between the actual trajectory and the reference trajectory is greater than a predefined value, computation by the computer of a first control vector comprising, for each second vehicle, a first correction component corresponding to the angle of orientation to be applied to the two wheels of the front axle assembly, multiplied by a first coefficient lying between 0 and 1, application of the first control vector to the two wheels of the front axle assembly of each second vehicle so as to minimize the deviation between the actual trajectory and the reference trajectory.

According to one embodiment, the trajectories are represented by components comprising the position and the orientation of the lead vehicle and, for each second vehicle, by a relative orientation corresponding to the orientation of the second vehicle relative to the orientation of the vehicle preceding it, and the determination of the deviation between the actual trajectory and the reference trajectory consists in computing, for each vehicle:
the difference between the components of its actual trajectory and the components of its reference trajectory,
the difference between the temporal drift of the components of its actual trajectory and the temporal drift of the components of its reference trajectory.

According to another embodiment, the computation of the first control vector is performed by means of a linear quadratic control method.

According to another embodiment, the first correction component of each second vehicle is less than 5 degrees.

According to another embodiment, each of the two wheels of the rear axle assembly of each vehicle comprising a motorization means and a brake, the stabilization method according to the invention comprises, if the deviation between the actual trajectory and the reference trajectory is greater than a predefined value:
a step of computation by the computer of a second control vector comprising, for each vehicle, a second correction component to be applied to the rear axle assembly of said vehicle, multiplied by a second coefficient lying between 0 and 1, the sum of the first coefficient and of the second coefficient being equal to 1, so as to minimize the deviation between the actual trajectory and the reference trajectory,
a step of application of the second control vector, by the motorization means and/or the brake, to the rear axle assembly of said vehicle.

According to another embodiment, the second correction component comprises a torque to be applied to the wheels of the rear axle assembly of said vehicle.

According to another embodiment, the stabilization method according to the invention comprises, for each vehicle, a step of distribution of the torque to be applied to the rear axle assembly of said vehicle as a first force to be applied to a first of the two wheels of the rear axle assembly of said vehicle and as a second force to be applied to a second of the two wheels of the rear axle assembly of said vehicle.

Advantageously, the computation of the correction components is performed in real time.

According to another embodiment, the computation of at least one correction component is performed just once in a predefined period, and the at least one correction component is estimated by linear interpolation between the adjacent correction components of its control vector during the predefined period.

According to another embodiment, each second vehicle comprising an actuator capable of applying to the articulation an effort on the rotation of the rear axle assembly relative to the front axle assembly of said vehicle, the stabilization method according to the invention comprises, if the deviation between the actual trajectory and the reference trajectory is greater than a predefined value:
a step of computation by the computer of a third control vector comprising, for each second vehicle, a third correction component to be applied to the articulation of said second vehicle, so as to minimize the deviation between the actual trajectory and the reference trajectory,
a step of application of the third control vector by the actuator to the articulation of said vehicle.

Advantageously, the stabilization method according to the invention comprises, prior to the application of the control vector, a step of saturation of the control vector to be applied to said vehicle.

The invention relates also to a convoy of vehicles linked in pairs one behind the other, intended to move on a reference plane along a reference trajectory, the convoy of vehicles following an actual trajectory, the convoy comprising:
a lead vehicle capable of moving along a main axis, comprising
   a front axle assembly with two wheels capable of being oriented along an axis of orientation forming, with the main axis, an angle of orientation,
   a rear axle assembly with two wheels that are rotationally mobile about a rear axis,
   a first sensor intended to estimate a position and an orientation of the lead vehicle,
at least one second vehicle comprising:
   a front axle assembly with two wheels that are rotationally mobile about a front axis,
   a rear axle assembly with two wheels that are rotationally mobile about a rear axis, the front axis of a second vehicle coinciding with the rear axis of the vehicle preceding it,
   an articulation configured to render the rear axle assembly rotationally mobile about a vertical axis substantially at right angles to the reference plane relative to the front axle assembly,
   a second sensor intended to estimate an orientation of the second vehicle,
a computer,
   the convoy being configured to implement such a stabilization method.

The invention will be better understood and other advantages will become apparent on reading the detailed description of an embodiment given by way of example, the description being illustrated by the attached drawing in which:

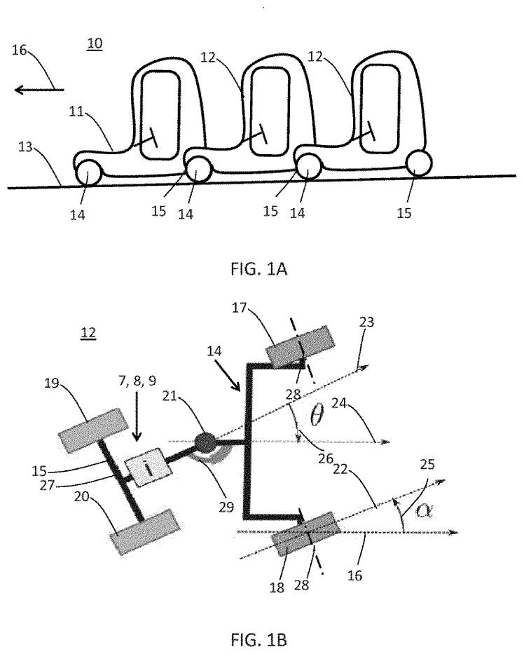

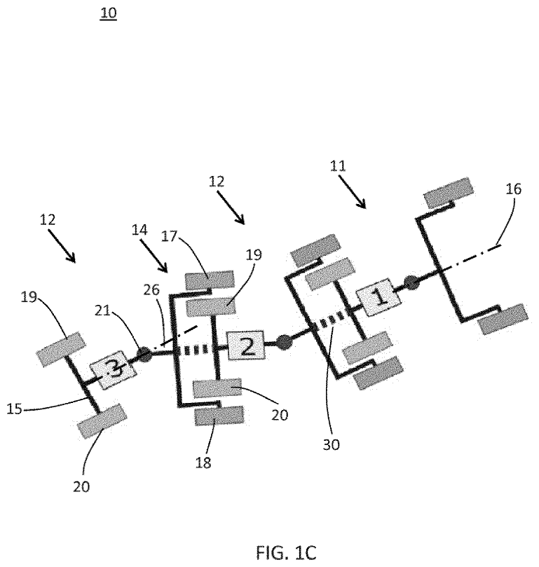

FIG. 1a schematically represents an embodiment of a convoy of vehicles according to the invention,

FIG. 1b schematically represents a vehicle seen from above according to the invention,

FIG. 1c schematically represents a convoy with three vehicles seen from above according to the invention,

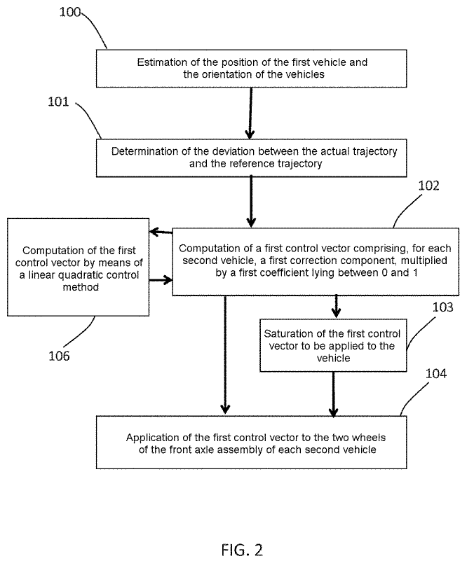

FIG. 2 schematically represents the steps of an embodiment of a control method according to the invention,

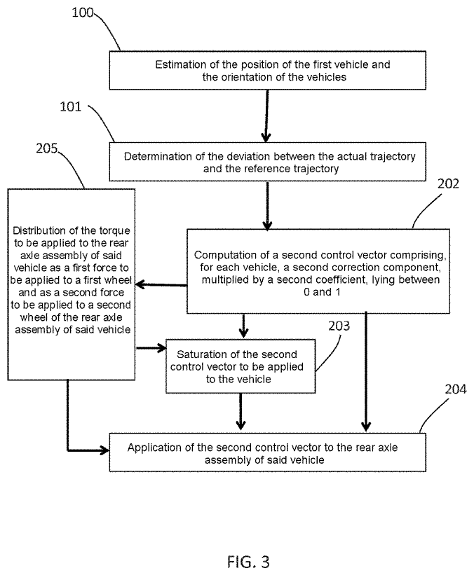

FIG. 3 schematically represents the steps of another embodiment of a control method according to the invention,

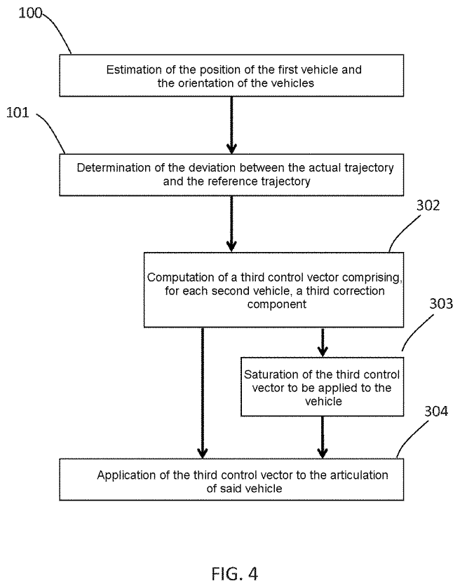

FIG. 4 schematically represents the steps of another embodiment of a control method according to the invention,

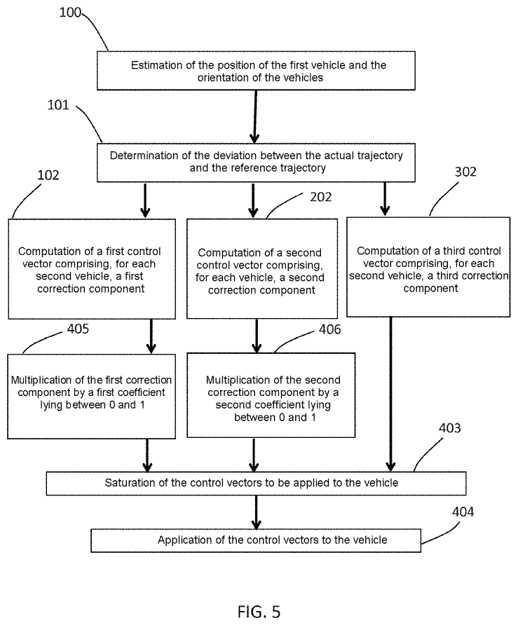

FIG. 5 schematically represents the steps of another embodiment of a control method according to the invention,

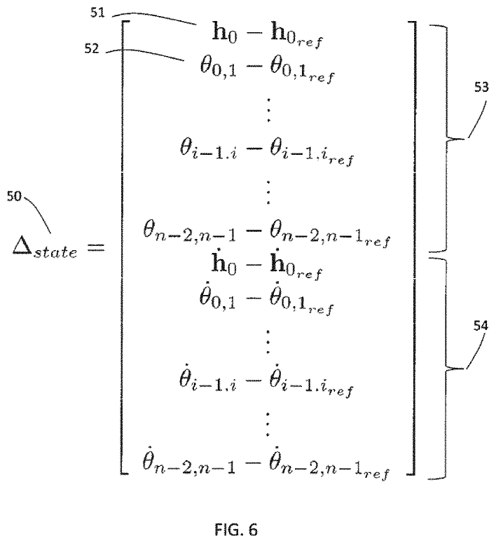

FIG. 6 represents an equation giving the deviation between the actual trajectory and the reference trajectory of the convoy of vehicles.

In the interests of clarity, the same elements will bear the same references in the different figures.

In the description, the invention is described with the example of a train composed of three vehicles. However, the invention is applicable to a train comprising, more generally, a plurality of vehicles, that is to say at least one lead vehicle and one following vehicle or several following vehicles one behind the other. Following vehicle should be understood to mean a vehicle that can advantageously also be a lead vehicle, but the following vehicle can also be passive, that is to say without driving capability, for example a trailer.

FIG. 1a schematically represents an embodiment of a convoy 10 of vehicles according to the invention. The convoy 10 comprises vehicles 11, 12 linked in pairs one behind the other, intended to move on a reference plane 13 along a reference trajectory, the convoy 10 of vehicles following an actual trajectory. The convoy 10 comprises a lead vehicle 11 capable of moving along a main axis 16, comprising a front axle assembly 14 with two wheels 17, 18 that are capable of being oriented along an axis of orientation 22 forming, with the main axis 16, an angle of orientation 25, a rear axle assembly 15 with two wheels 19, 20 that are rotationally mobile about a rear axis 27, a first sensor 7 intended to measure a position and an orientation of the lead vehicle 11. The term first sensor should be taken in the broad sense. The first sensor 7 can be a measurement sensor, for example a GPS or an inertial unit, but it can also be a means for estimating the position and the orientation of the lead vehicle 11, making it possible to make an estimation based on the rotation of the wheels and the steering lock angles, possibly with the aid of a gyrometer. The convoy 10 comprises at least one second vehicle 12 comprising a front axle assembly 14 with two wheels 17, 18 that are rotationally mobile about a front axis 28, a rear axle assembly 15 with two wheels 19, 20 that are rotationally mobile about a rear axis 27, the front axis 28 of a second vehicle 12 coinciding with the rear axis 27 of the vehicle preceding it, an articulation 21 configured to render the rear axle assembly 15 rotationally mobile about a vertical axis substantially at right angles to the reference plane 13 relative to the front axle assembly 14, the axis at right angles to the rear axle assembly 15 then forming angle 26 with the main axis 16, a second sensor 8 intended to estimate or measure an orientation of the second vehicle 12, and a computer 9.

FIG. 1b schematically represents a vehicle 12 seen from above according to the invention. This representation makes it possible to visualize the possible mobilities of the vehicle 12. The wheels 17, 18 of the front axle assembly 14 can be oriented by an angle of orientation 25. The articulation 21 makes it possible to pivot the rear axle assembly 15 relative to the front axle assembly 14, by rotating it about the vertical axis substantially at right angles to the reference plane 13.

The lead vehicle 11 does not necessarily have any articulation 21 since it is the tractor vehicle and, consequently, it does not require rotational mobility of the rear axle assembly relative to the front axle assembly. However, the invention applies similarly to a lead vehicle 11 with an articulation 21. It is even advantageous to have a lead vehicle 11 identical to the second vehicles 12. In other words, all the vehicles are advantageously identical. And in a case of application that is cited, in a vehicle self-service station, the driver can use any vehicle 12 as lead vehicle 11, thus facilitating the logistical aspect of the fleet of vehicles. In this case, or in the case of an isolated vehicle, that is to say one used alone, the vehicle 12 serving as lead vehicle has its articulation 21 blocked. In other words, the articulation 21 is configured such that the angle 26 is nil.

The vehicles 11, 12 can also each comprise a power cylinder 29 positioned at the articulation 21 capable of acting on the rotational movement of the rear axle assembly relative to the front axle assembly.

FIG. 1c schematically represents the convoy 10 with three vehicles seen from above according to the invention. In vehicle convoy mode, the vehicles 11, 12 are linked mechanically, rigidly, with an elasticity to within a very great stiffness, for an issue of feasibility. The inter-vehicle links 30 are such that the rear axis 27 of the rear axle assembly of the preceding vehicle coincides with the front axis 28 of the front axle assembly of the vehicle concerned. For example, the rear axis 27 of the rear axle assembly of the vehicle 11 coincides with the front axis 28 of the front axle assembly of the vehicle 12 linked to the vehicle 11. The front wheels 17, 18 of the lead vehicle 11 can be oriented so as to direct the convoy 10 of vehicles. The front wheels 17, 18 of the second vehicles 12 are nominally configured such that the angle 25 is nil, that is to say that the front wheels 17, 18 are oriented along the main axis 16, but possibly the wheels 17, 18 can be oriented according to a small angle for the purposes of stabilization of the convoy, as explained later.

The reference trajectory of the convoy is composed of the actual trajectory of the lead vehicle 11 and the trajectory of the second vehicles 12 driven by the lead vehicle 11 and to which no external effort is applied. In other words, the reference trajectory is described by the trajectory of the lead vehicle 11 and the trajectory of the second vehicles 12 which follow the lead vehicle 11 as they may, without external strains or efforts. The reference trajectory is derived from the kinematics and represents a unique configuration. Advantageously, the computer 9 is positioned in the lead vehicle 11 and communicates by wire or wirelessly with the sensors 7, 8. For the same reasons mentioned previously, it is advantageous to have a lead vehicle 11 that is identical to the second vehicles 12, in which case each vehicle 11, 12 can comprise a computer 9. The computers 9 of each vehicle can compute a trajectory and communicate with one another, by wire or wirelessly.

FIG. 2 schematically represents the steps of an embodiment of a control method according to the invention. The method according to the invention comprises the following steps. First of all, the method comprises a step 100 of estimation by the sensors 7, 8 of the position of the lead vehicle 11 and the orientation of the vehicles 11, 12. As explained previously, the sensors 7, 8 can be estimation means making it possible to estimate the position and the orientation of the vehicles. They can also be measurement sensors, in which case the estimation step 100 corresponds to a step of measurement of the position and the orientation of the vehicles. In this case, the sensor 7 measures the position of the lead vehicle 11 and each of the sensors 8 measures the position and the orientation of the vehicle 11, 12 with which it is associated. Such position and orientation information is transmitted, by wire or wirelessly, to the computer 9. Next, the method according to the invention comprises a step 101 of determination by the computer 9 of the deviation between the actual trajectory and the reference trajectory from the estimations of the sensors 7, 8. The computer 9 is configured to determine the reference trajectory from the trajectory of the lead vehicle 11 and from kinematic equations. Following the step 100, the computer 9 is capable of computing the actual trajectory of the convoy 10 from the position and the orientation of the second vehicles 12.

FIG. 6 represents an equation giving the deviation 50 between the actual trajectory and the reference trajectory of the convoy of vehicles. The index “ref” refers to the reference trajectory. The vector 51 denoted h is a vector comprising the orientation of a vehicle and its position. h index “ref” is therefore the vector comprising the orientation and the position of a vehicle for its reference trajectory and h is the vector comprising the orientation and the position of a vehicle for its actual trajectory. The angle 52 is the difference of orientation 26 of the vehicle considered relative to the preceding vehicle. For example, for the second vehicle 12 in the second position of the convoy, the angle 52 corresponds to the difference of orientation 26 of this second vehicle relative to the one preceding it, that is to say the lead vehicle 11. The angle 52 therefore takes for its value the difference between the angle 26 of the second vehicle 12 and the angle 26 of the lead vehicle 11. The deviation 50 is thus computed by considering in pairs all the vehicles 11, 12 of the convoy 10.

The part 53 of the deviation 50 corresponds to the values cited previously and the part 54 of the deviation 50 corresponds to the temporal drifts of the values cited previously. Thus, the trajectories are represented by components 53 comprising the position and the orientation of the lead vehicle 11 and, for each second vehicle 12, by a relative orientation corresponding to the orientation of the second vehicle 12 relative to the orientation of the vehicle preceding it, and the determination of the deviation 50 between the actual trajectory and the reference trajectory consists in computing, for each vehicle, the different between the components of its actual trajectory and the components of its reference trajectory (part 53) and the difference between the temporal drift of the components of its actual trajectory and the temporal drift of the components of its reference trajectory (part 54).

Thus, the configuration of the convoy is represented by the orientation and the position of each vehicle, and more specifically, for each of the second vehicles 12, by its relative orientation relative to the vehicle preceding it.

If the deviation between the actual trajectory and the reference trajectory is not nil or much greater than a predefined value, the method comprises a step 102 of computation by the computer 9 of a first control vector comprising, for each second vehicle 12, a first correction component corresponding to the angle of orientation 25 to be applied to the two wheels 17, 18 of the front axle assembly 14. The first control vector makes it possible to use the drive wheels 17, 18 arranged at the front of each second vehicle 12. The modification of the direction of the drive wheels 17, 18 makes it possible to apply, by reaction, lateral efforts at the connection linking two consecutive vehicles of the convoy 10.

In nominal operation, the axes of rotation 27 of the rear axle assembly 15 of the preceding vehicle and the axes of rotation 28 of the wheels of the front axle assembly of the following vehicle coincide. A modification of the direction of the drive wheels 17, 18 destroys this collinearity and leads to a relative skid. However, assuming that the orientation of the wheels 17, 18, that is to say the value of the first correction component, is low, this skid remains tolerable, for example less than 15 degrees. Advantageously, the first correction component of each second vehicle is less than 5 degrees.

From the error vector 50, the method according to the invention seeks to determine a setpoint angle, or control angle, for at least one of the second vehicles 12. The method according to the invention uses a global method that makes it possible to compute a correction in the form of the product of a matrix by the error vector 50, the result of the computation being the angles of orientation 25 of all the second vehicles. Also, the computation of the first control vector (step 102) is performed by means of a linear quadratic control method (step 106). This method requires the choice of a point (or state or configuration and speed) of operation around which the system is linearized. It is sufficient, to simplify the computations, to choose a linearization around a configuration such that all the vehicles are aligned and at the speed close to that of the actual convoy.

The invention is therefore based on a vector and matrix representation of the convoy of vehicles.

The kinematic model of the convoy can be represented by a set of constraints by imposing the longitudinal speed on the lead vehicle, that there is no lateral speed of the wheels and that there is the same translational speed at the level of articulation of two successive vehicles. The kinematic model makes it possible to determine the kinematic torques of each vehicle, each kinematic torque comprising the angular speed of the vehicle and a 2D translational speed vector.

The dynamic model is constructed in a modular fashion by considering all the vehicles as rigid solids coupled by dynamic stresses. Here, the dynamic model does not include any model of longitudinal wheel-ground behavior, considered to be perfect. Only a model of lateral wheel-ground behavior is considered. The dynamic model makes it possible to determine the dynamic torques of each vehicle, each dynamic torque comprising the moment of the vehicle and a 2D force speed vector. By writing the dynamic equations of a convoy of vehicles and by taking into account the dynamic equations associated with the ground-wheel contact, the stresses on the effort torques and the kinematic stresses, and by linearizing the resulting equations, the linearized dynamic model is obtained. It is then possible to compute the first control vector using a linear quadratic control method.

The computation of the first correction components can be performed in real time. Alternatively, in order to ensure an adjustment at all speeds and by noting that, for two nominal speeds, one of which is half the other, the coefficients of the first control vector are not too far apart, it is possible to envisage applying a piecewise linear interpolation between these coefficients as a function of the speed. In other words, the computation of at least one first correction component can be performed just once in a predefined period, and the at least one correction component is estimated by linear interpolation between the adjacent correction components of its control vector during the predefined period. The linear interpolation makes it possible to limit the computation time of the first control vector. This computation time saving is very important since the application of the trajectory corrections to be applied to the convoy 10 must be very reactive in order to correct the trajectory as soon as the slightest deviation occurs.

For each second vehicle 12, the first correction component corresponding to the angle of orientation 25 to be applied to the two wheels 17, 18 of the front axle assembly 14 is multiplied by a first coefficient lying between 0 and 1. The weighting by the first coefficient is intended to couple the first control vector to a second control vector, as explained later.

The linear quadratic control method does not deal with the limitation of the angles of orientation 25. A final saturation stage bounds the control as a function of maximum speeds and amplitudes of orientation. The method according to the invention therefore advantageously comprises a step 103 of saturation of the first control vector to be applied to said vehicle.

To finish, the method comprises a step 104 of application of the first control vector to the two wheels of the front axle assembly of each second vehicle so as to minimize the deviation between the actual trajectory and the reference trajectory. It is therefore the application of the first control vector as initially computed on which each computed component, that is to say the first correction components, has been multiplied by the first coefficient, then saturated.

Thus, from the deviation 50, the method according to the invention makes it possible to obtain a correction in the form of an angle of orientation of the wheels of one, two or more second vehicles 12. The wheels of all the second vehicles can therefore receive a control correcting their angle of orientation.

FIG. 3 schematically represents the steps of another embodiment of a control method according to the invention. This embodiment is described in this figure as an isolated embodiment independent of the embodiment presented in FIG. 2. It will be seen later that this embodiment of the control method can also be implemented in combination, successively or in parallel, with the embodiment presented in FIG. 2.

First of all, and like the embodiment presented in FIG. 2, the method comprises a step 100 of estimation (or of measurement) by the sensors 7, 8 of the position of the lead vehicle 11 and the orientation of the vehicles 11, 12. The sensor 7 estimates (or measures) the position of the lead vehicle 11 and each of the sensors 8 estimates (or measures) the position and the orientation of the vehicle 8 with which it is associated. Such position and orientation information is transmitted, by wire or wirelessly, to the computer 9. Next, the method according to the invention comprises a step 101 of determination by the computer 9 of the deviation between the actual trajectory and the reference trajectory from the estimations or measurements of the sensors 7, 8. The computer 9 is configured to determine the reference trajectory from the trajectory of the lead vehicle 11 and from kinematic equations. Following the step 100, the computer 9 is capable of computing the actual trajectory of the convoy 10 from the position and the orientation of the second vehicles 12.

In the embodiment of the method presented in FIG. 3, each of the two wheels 19, 20 of the rear axle assembly 15 of each vehicle 11, 12 comprises a motorization means and a brake. The motorization means are independent and the brake of each wheel can be controlled independently.

If the deviation between the actual trajectory and the reference trajectory is not nil or greater than a predefined value, the method according to the invention comprises a step 202 of computation by the computer 9 of a second control vector comprising, for each vehicle 11, 12, a second correction component to be applied to the rear axle assembly 15 of said vehicle. Thus, at each inter-vehicle link, it is possible to control the propulsion or braking force as well as the moment via a suitable combination of motor torque and brake torque. The second correction component comprises a torque to be applied to the wheels of the rear axle assembly of said vehicle.

The second control vector is computed by following the same approach as that of the computation of the first control vector. By solving the equations mentioned previously, it is then possible to compute the second control vector using a linear quadratic control method. In this case, the second control vector corresponds to a torque to be applied to the rear axle assembly of the vehicles.

Using the chosen set of equations, by linearizing the systems of equations, it is then possible to obtained two control vectors, one for the orientation of the front wheels of the vehicles, the other for the torque to be applied to the rear axle assembly of the vehicles. This computation method is advantageous since it makes it possible to provide two different types of correction which can be combined or else used separately, that is to say applied at the same time or successively, or else one type of correction can be deactivated without in any way deactivating the other type of correction.

The method according to the invention comprises, for each vehicle, a step 205 of distribution of the torque to be applied to the rear axle assembly 15 of said vehicle as a first force to be applied to a first of the two wheels of the rear axle assembly 15 of said vehicle and as a second force to be applied to a second of the two wheels of the rear axle assembly 15 of said vehicle.

The method according to the invention can provide a correction corresponding to the control which computes a translational force and a setpoint rotational moment which are reflected by torques on the wheels, that can be positive or negative independently. The activation of the motorization means and/or of the brake of at least one wheel of the rear axle assembly is done to respond to the needs of trajectory correction to be applied to the convoy of vehicles. In other words, the activation of the motorization means and/or of the brake of at least one wheel of the rear axle assembly, which results from the computation of the second control vector, can take place to correct the speed, the acceleration or deceleration of the convoy, but also this activation can take place to reduce the deviation between the actual trajectory and the reference trajectory of the convoy of vehicles, therefore not necessarily for a correction in terms of speed or speed variations, but simply in terms of positioning of the vehicles.

The limitations or saturations of controls must take account of the aspects of dissymmetry for one and the same wheel between the maximum motor torque (ensured by the motorization means of the wheel for which the maximum torque decreases as a function of speed) and the maximum resisting torque, depending primarily on the braking, that is greater as an absolute value. The limitations or saturations of controls must also take account of the aspects of coupling management between propulsion (that is to say a longitudinal force) and moment for the stabilization of the convoy 10.

A choice is made to prioritize the stabilization, i.e. the moment computed by the computer. Once this moment value is computed, it is distributed as best it can be over the two wheels as a function of the saturations, managed on each wheel. The propulsion control is computed in a second stage, which means that the convoy of vehicles can be braked or slowed down if the stabilization requires it even if, in terms of propulsion, acceleration were necessary.

The computation of the second correction components can be performed in real time. Alternatively, in order to ensure an adjustment at all speeds and noting that, for two nominal speeds, one of which is half the other, the coefficients of the second control vector are not too far apart, it is possible to envisage applying a piecewise linear interpolation between these coefficients as a function of the speed. In other words, the computation of at least one second correction component can be performed just once in a predefined period, and the at least one correction component is estimated by linear interpolation between the adjacent correction components of its control vector during the predefined period. The linear interpolation makes it possible to limit the computation time of the first control vector. This computation time saving is very important since the application of the trajectory corrections to be applied to the convoy 10 must be very reactive in order to correct the trajectory as soon as the slightest deviation occurs.

For each vehicle, the second correction component to be applied to the rear axle assembly 15 is multiplied by a second coefficient lying between 0 and 1, the sum of the first coefficient and of the second coefficient being equal to 1. The weighting by the second coefficient is intended to couple the second control vector to the first control vector, as mentioned previously. More specifically, the control method can consist of a linear combination of the first and of the second control vectors. The values taken by the first and second coefficients make it possible to combine the two corrections to be applied (to the orientation of the wheels of the front axle assembly and to the torque and the braking to be applied to the rear axle assembly). The linear combination of these two corrections makes it possible to prioritize one of the two corrections, for example the orientation of the wheels 17, 18, by giving the first coefficient a value closer to 1. The values attributed to the first and second coefficients can be adjusted over time, depending on the type of correction desired, depending on whether emphasis is to be placed on the orientation of the wheels of the front axle assembly or on the torque and/or braking of the rear axle assembly. This linear combination also makes it possible to disconnect one of the corrections, by attributing a nil value to the associated coefficient. For example, if there is no desire to modify the orientation of the wheels of the axle assembly of the second vehicles, it is sufficient to set the first coefficient at 0. Finally, the combination of the two corrections allows a more effective trajectory correction since it associates two correctors, both the angle of orientation of the wheels and the torque to be applied to the rear axle assembly, which allows the convoy of vehicles to remain as close as possible to reference trajectory in terms of positioning and speed.

A final saturation stage bounds the control as a function of the maximum torque. The method according to the invention therefore advantageously comprises a step 203 of saturation of the second control vector to be applied to said vehicle.

To finish, the method comprises a step 204 of application of the second control vector, by the motorization means and/or the brake to the rear axle assembly of said vehicle, so as to minimize the deviation between the actual trajectory and the reference trajectory. It is therefore the application of the second control vector as initially computed on which each computed component, that is to say the second correction components, has been multiplied by the second coefficient, then saturated.

FIG. 4 schematically represents the steps of another embodiment of a control method according to the invention. This embodiment is described in this figure as an isolated embodiment independent of the embodiments presented in FIGS. 2 and 3. It will be seen later that this embodiment of the control method can also be implemented in combination, successively or in parallel, with the embodiment presented in FIG. 2 and/or the embodiment presented in FIG. 3.

In this embodiment, each second vehicle 12 comprises an actuator capable of applying to the articulation 21 an effort resisting the rotation of the rear axle assembly 15 relative to the front axle assembly 14 of said vehicle. The method comprises, if the deviation between the actual trajectory and the reference trajectory is not nil or greater than a predefined value, a step 302 of computation by the computer 9 of a third control vector comprising, for each second vehicle 12, a third correction component to be applied to the articulation 21 of said second vehicle, so as to minimize the deviation between the actual trajectory and the reference trajectory.

This correction relies on a power cylinder controlled by resisting effort. It is a passive actuator, having the advantage of consuming little energy. Contrary to an active actuator, this power cylinder does not apply a required effort, but only an effort resisting the movement, equal to the effort desired when the movement is effected, and less than the effort desired (even nil) when there is no longer movement. It is possible, in a simplified manner, to represent this control as a dry friction whose maximum effort value is controlled.

Since this control is essentially passive, applying a linear quadratic control method is very conservative: the gains are too low and insufficient to stabilize the convoy. It is preferable to implement a diagonal controller, the control being proportional to the error on the corresponding articulation, with great gains.

Associated with this feature, there is a difficulty that has to be dealt with. In the case where the articulation tends to move in the same direction as the resisting moment, the computer must cancel the control in order not to prevent a movement in the direction of the desired correction. That requires a movement direction detector to be put in place (for each articulation, that can be produced in different ways: by using a measurement of speed or else effort or pressure (in the case of a hydraulic or pneumatic power cylinder), the last two solutions (effort or pressure) being best suited to the problem.

The action of the cylinder is not therefore to act such that the angle 26 lies between an authorized minimum value and an authorized maximum value, but to apply a resisting effort to the movement. The resisting effort applied is not necessarily associated with the angle 25 of orientation of the wheels 17, 18. The resisting effort applied can in particular be determined by the type of power cylinder used. For example, the power cylinder can be of hydraulic type, with a check valve held by a spring. A pressure is then applied to the check valve and beyond a certain predefined pressure, the check valve is moved and there is movement of the power cylinder. The pressure can be applied in one direction or in another.

A final stage of saturation bounds the control as a function of the maximum damper. The method according to the invention therefore advantageously comprises a step 303 of saturation of the third control vector to be applied to said vehicle.

Finally, the method comprises a step 304 of application of the third control vector by the actuator to the articulation of said vehicle.

FIG. 5 schematically represents the steps of another embodiment of a control method according to the invention. This figure illustrates the possible combinations between the different embodiments of a control method. Each embodiment can be implemented individually. Equally, it is possible to aggregate two of them, for example the computation of the first control vector and the computation of the second control vector or the computation of the first control vector and the computation of the third control vector, or even the computation of the second control vector and the computation of the third control vector, or even all three (with application of the multiplying coefficient/coefficients and of the saturation) to apply to the vehicle(s) the corresponding control vectors. Thus combined, the three approaches complement one another without it being necessary to prioritize one or other. For example, in case of loss of grip, it is primarily the power cylinder which ensures the stabilization of the convoy of vehicles without it being necessary to modify the control law. It can be noted that, since the actuation of the power cylinder is passive, it is added to the other corrections. This is what explains the absence of coefficient between 0 and 1, contrary to the corrections corresponding to the first and second control vectors.

The result thereof is a more comprehensive control of the convoy, well suited to the deviations of the vehicles with respect to the reference trajectory, more reactive and therefore more effective. The invention relies on the fact that the convoy does not enter into oscillation. In effect, the oscillations cannot develop since, as soon as the slightest deviation is detected, the control method is immediately implemented.

The invention relates also to a convoy configured to implement a control method as described previously. More specifically, the computer 9 is configured to implement such a method. For logistical facility reasons, it is advantageous for all the vehicles to be identical, but it can be noted that the presence of a computer in each vehicle is not mandatory. The invention applies with at least a computer 9 in the lead vehicle. In this case, the sensors of the second vehicles communicate their data to the computer 9.

1. A method for stabilization by orientation of a convoy of vehicles linked in pairs one behind the other, intended to move on a reference plane along a reference trajectory, the convoy of vehicles following an actual trajectory, the convoy comprising:
a lead vehicle capable of moving along a main axis, comprising:
a front axle assembly with two wheels capable of being oriented along an axis of orientation forming, with the main axis an angle of orientation,
a rear axle assembly with two wheels that are rotationally mobile about a rear axis,
a first sensor intended to estimate a position and an orientation of the lead vehicle,
at least one second vehicle comprising:
a front axle assembly with two wheels that are rotationally mobile about a front axis,
a rear axle assembly with two wheels that are rotationally mobile about a rear axis, the front axis of a second vehicle coinciding with the rear axis of the vehicle preceding it,
an articulation configured to render the rear axle assembly rotationally mobile about a vertical axis substantially at right angles to the reference plane relative to the front axle assembly,
a second sensor intended to estimate an orientation of the second vehicle, a computer,
the reference trajectory of the convoy being composed of the actual trajectory of the lead vehicle and the trajectory of the second vehicles driven by the lead vehicle and to which no external effort is applied,
the method being wherein it comprises the following steps:
estimation by the sensors of the position of the lead vehicle and the orientation of the vehicles,
determination by the computer of the deviation between the actual trajectory and the reference trajectory from the estimations of the sensors,
if the deviation between the actual trajectory and the reference trajectory is greater than a predefined value, computation by the computer of a first control vector comprising, for each second vehicle, a first correction component corresponding to the angle of orientation to be applied to the two wheels of the front axle assembly, multiplied by a first coefficient lying between 0 and 1,
application of the first control vector to the two wheels of the front axle assembly of each second vehicle so as to minimize the deviation between the actual trajectory and the reference trajectory.

2. The stabilization method as claimed in claim 1, wherein the trajectories are represented by components comprising the position and the orientation of the lead vehicle and, for each second vehicle, by a relative orientation corresponding to the orientation of the second vehicle relative to the orientation of the vehicle preceding it, in that the determination of the deviation between the actual trajectory and the reference trajectory consists in computing, for each vehicle:
the difference between the components of its actual trajectory and the components of its reference trajectory,
the difference between the temporal drift of the components of its actual trajectory and the temporal drift of the components of its reference trajectory.

3. The stabilization method as claimed in claim 2, wherein the computation of the first control vector is performed by means of a linear quadratic control method.

4. The stabilization method as claimed in claim 1, wherein, the first correction component of each second vehicle is less than 5 degrees.

5. The stabilization method as claimed in claim 1, each of the two wheels of the rear axle assembly of each vehicle comprising a motorization means and a brake, wherein it comprises, if the deviation between the actual trajectory and the reference trajectory is greater than a predefined value:
a step of computation by the computer of a second control vector comprising, for each vehicle, a second correction component to be applied to the rear axle assembly of said vehicle, multiplied by a second coefficient lying between 0 and 1, the sum of the first coefficient and of the second coefficient being equal to 1, so as to minimize the deviation between the actual trajectory and the reference trajectory,
a step of application of the second control vector, by the motorization means and/or the brake to the rear axle assembly of said vehicle.

6. The stabilization method as claimed in claim 5, wherein that the second correction component comprises a torque to be applied to the wheels of the rear axle assembly of said vehicle.

7. The stabilization method as claimed in claim 6, wherein it comprises, for each vehicle, a step of distribution of the torque to be applied to the rear axle assembly of said vehicle as a first force to be applied to a first of the two wheels of the rear axle assembly of said vehicle and as a second force to be applied to a second of the two wheels of the rear axle assembly of said vehicle.

8. The stabilization method as claimed in claim 1, wherein the computation of the correction components is performed in real time.

9. The stabilization method as claimed in claim 1, wherein the computation of at least one correction component is performed just once in a predefined period, and in that the at least one correction component is estimated by linear interpolation between the adjacent correction components of its control vector during the predefined period.

10. The stabilization method as claimed in claim 1, each second vehicle comprising actuator capable of applying to the articulation an effort on the rotation of the rear axle assembly relative to the front axle assembly of said vehicle, wherein it comprises, if the deviation between the actual trajectory and the reference trajectory is greater than a predefined value:
a step of computation by the computer of a third control vector comprising, for each second vehicle, a third correction component to be applied to the articulation of said second vehicle, so as to minimize the deviation between the actual trajectory and the reference trajectory, a step of application of the third control vector by the actuator to the articulation of said vehicle.

11. The stabilization method as claimed in claim 1, wherein it comprises, prior to the application of the control vector, a step of saturation of the control vector to be applied to said vehicle.

12. A convoy of vehicles linked in pairs one behind the other, intended to move on a reference plane along a reference trajectory, the convoy of vehicles following an actual trajectory, the convoy comprising:
a lead vehicle capable of moving along a main axis, comprising:
a front axle assembly with two wheels capable of being oriented along an axis of orientation forming, with the main axis an angle of orientation,
a rear axle assembly with two wheels that are rotationally mobile about a rear axis,
a first sensor intended to estimate a position and an orientation of the lead vehicle,
at least one second vehicle comprising:
a front axle assembly with two wheels that are rotationally mobile about a front axis,
a rear axle assembly with two wheels that are rotationally mobile about a rear axis, the front axis of a second vehicle coinciding with the rear axis of the vehicle preceding it,
an articulation configured to render the rear axle assembly rotationally mobile about a vertical axis substantially at right angles to the reference plane relative to the front axle assembly,
a second sensor intended to estimate an orientation of the second vehicle,
a computer,
wherein the convoy is configured to implement a stabilization method as claimed in claim 1.
